(19) United States
(12) Patent Application Publication
(10) Pub. No.: US 2007/0076676 A1
(43) Pub. Date: Apr. 5, 2007

(54) Power line communication adaptor and power line communication system

(75) Inventor: Toshifumi Shiba, Iruma-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/528,581

(22) Filed: Sep. 28, 2006

(30) Foreign Application Priority Data
Sep. 30, 2005 (JP) 2005-285757

(51) Int. Cl. H04H 1/00

(52) U.S. Cl. 370/339

(57) ABSTRACT

According to one embodiment, a power line communication adaptor includes a power converter section which coverts an AC voltage supplied from a power line to a DC voltage driving a communication terminal, a signal converter which demodulates a communication signal superimposed on the AC voltage, which converts the demodulated communication signal for supply to the communication terminal, and which converts the communication signal that is supplied from the communication terminal to a signal for supply to the power line, a connector being to be connected to a cable configured to transmit a DC voltage supplied from the power converter and a signal for communication between the signal converter and the communication terminal; and a controller which determines whether or not the DC voltage is supplied to the communication terminal and which controls supply of the DC voltage to the connector in response to the determination result.

### CROSS-REFERENCE TO RELATED APPLICATIONS

This application is based upon and claims the benefit of priority from Japanese Patent Application No. 2005-285757, filed Sep. 30, 2005, the entire contents of which are incorporated herein by reference.

### BACKGROUND

1. Field

One embodiment of the invention relates to a power line communication adaptor and a power line communication system for operating power line communication.

2. Description of the Related Art

In conjunction with each person owning a personal computer due to diffusion of the Internet and falling prices of personal computers, and networking of information appliances as seen, for example, in import of TV program listing from the Internet, there is a demand for internet connection at various spots within houses.

In many cases, a personal computer and an intelligent home appliance (“terminal”, hereafter) having a network interface, such as the ones described above and a gateway device (“gateway”, hereafter) for connecting the Internet and the home network have a wired network interface with a twisted pair cables, such as those complying with 110BASE-TX or 10BASE-T standards, being used as a physical medium.

When installing a device, such as a terminal and a gateway at various spots within a house, in order to connect them with a twisted pair cable, wiring construction becomes necessary unless cable wiring preliminarily exists, thereby increasing the cost in addition to the cost of purchased equipment.

Accordingly, as networks which do not necessitate such new wiring construction, a wireless LAN and a power line communication are widely used, or there exists a trend thereto.

Especially, a power line communication covers the entirety of the communication in a house. Different from the wireless LAN, while all devices such as terminals and gateways have to be connected to the power line, there are no limitations in the transmission distance or security problems. For these advantages, the power line communication system is appreciated as a most attractive medium for use as a wiring system of the home network.

In many cases, as power sources for terminals and gateways, AC adaptors are used in consideration of cost and device size reduction. An AC adaptor of this type converts alternating current (AC) power to low voltage direct current (DC) power, in which a signal superimposed onto the power line is attenuated or discontinued. Accordingly, the AC voltage has to be directly input to a terminal or gateway, in order to cause the terminal or gateway to directly perform power line communication. However, in this case, not only unnecessary costs are required for a usage instance not involving the power line communication, but also it is difficult to achieve physical compactness of the device.

Hence, there has been proposed a device that performs connection control between a power line and a 100BASE-TX/10BASE-TX interface, which is an existing network interface provided as a standard component for almost all types of terminals (see Jpn. Pat. Appln. KOKAI Publication No. 2004-48236).

Using the device minimizes the necessity of rework of wiring, and concurrently makes it possible to install terminal and gateway at any spot within a house.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing the Internet and a home network system according to one embodiment of the invention;

FIG. 2 is an exemplary diagram showing a system configuration of a gateway and an adaptor according to one embodiment of the invention; and

FIG. 3 is an exemplary flow diagram showing a procedure for detecting whether a DC voltage can be supplied to the gateway.

### DETAILED DESCRIPTION

Various embodiments according to the invention will be described hereinafter with reference to the accompanying drawings. In general, according to one embodiment of the invention, a power line communication adaptor comprises a power converter section which coverts an alternating current (AC) voltage to a direct current (DC) voltage, the AC voltage is supplied from a plug section which is coupled to a power line plug socket connected to a power line, and the DC voltage drives a communication terminal, a signal converter section which demodulates a communication signal superimposed on the AC voltage, which converts the demodulated communication signal to a signal defined between the signal converter section and the communication terminal, and which converts the communication signal that is supplied from the communication terminal to a signal compliant with a standard for supply to the power line, a first connector being to be connected to a first cable configured to transmit a DC signal supplied from the power converter section and a signal for communication between the signal converter section and the communication terminal, and a control section which determines whether or not the DC voltage is supplied to the communication terminal and which controls supply of the DC voltage to the connector in response to the determination result.

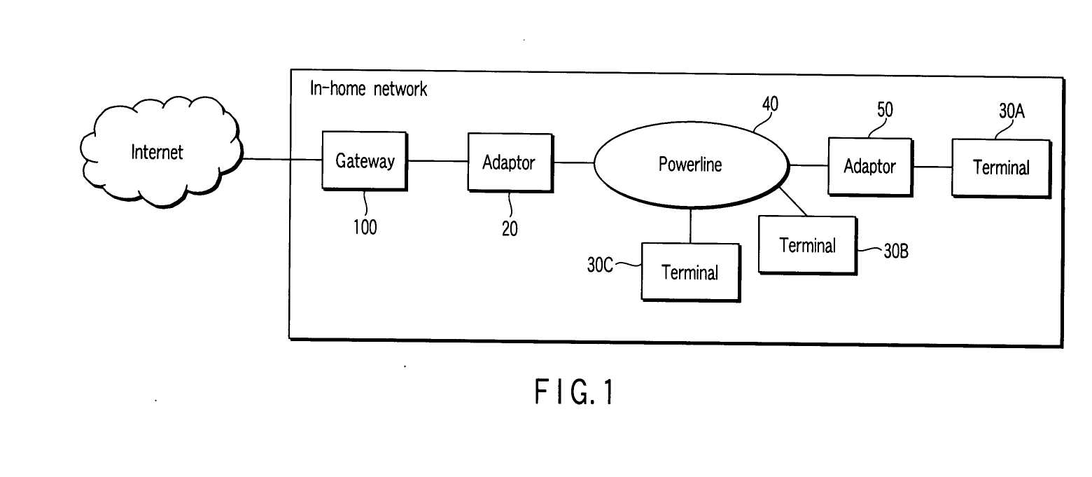

FIG. 1 is a diagram showing the Internet and a home network system.

A gateway 100 provided as a communication terminal has a function of connecting the Internet and a home network.

An adaptor 20 is located between gateway 100/terminals 30A-30C and a power line 40. The adaptor 20 has a function of providing communication control between the terminals 30A to 30C and the gateway 100 that are connected to the power line 40, and a function of supplying DC voltage to the gateway 100/terminals 30A-30C.

The terminals 30A to 30C thus connected to the power line 40 are devices capable of performing communication through the power line 40. The terminals 30A to 30C are classified into the type connected to the power line 40 through an adaptor 50, and type directly connected to the power line 40.

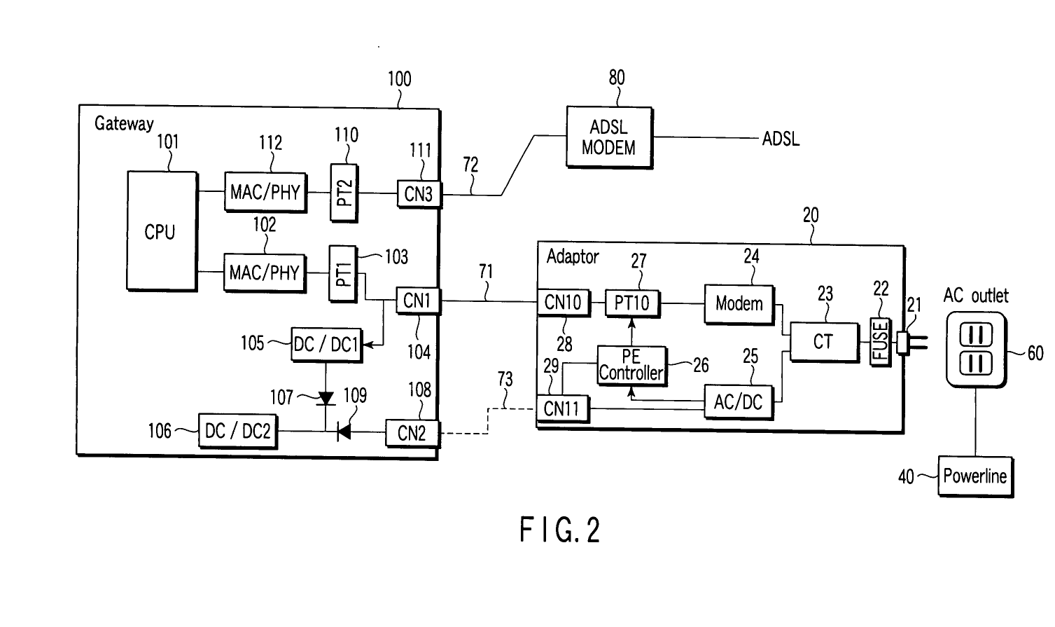

FIG. 2 is a diagram showing a system configuration of the gateway 100 and the adaptor 20.

A power source plug 21 is connected to an AC outlet (power line plug socket) 60 and is connected to the power line 40 in a house. A fuse 22 has a disconnecting function when AC current input from the power source plug 21 exceeds a predetermined level. A coupler (CT) 23 has functions of separating a signal received from the power source plug 21 through the fuse 22 into a high frequency component and an AC component of the power source. The high frequency component is output to a modem 24. The AC component is output to an AC/DC converter (“AC/DC”) 25. The coupler 23 has a function of outputting a signal output from the modem 24 to the power line 40 through the fuse 22 and the power source plug 21.

The modem 24 has a function of converting the signal supplied from the coupler 23 to a communication signal suitable or acceptable to a physical layer/MAC (medium access control) layer defined between itself and the gateway 100. The modem 24 further has a function of converting a signal supplied from the gateway 100 to a signal suitable or acceptable to the physical layer/MAC layer.

The AC/DC converter 25 is a device that converts the AC voltage output from the coupler 23 to the DC voltage. A PE controller 26 has a function of determining from an output voltage supplied from a pulse transformer 27 whether the DC voltage can be supplied to the gateway 100, and supplying the DC voltage to the pulse transformer 27 if the DC voltage can be supplied to the gateway 100.

The pulse transformer 27 outputs to a connector (“CN10”) 28 a signal supplied from the modem 24 and a DC voltage supplied from the PE controller 26. The connector 28 is a connector that effects cable connection to the gateway 100.

Twisted-pair cables 71 and 72, respectively, are wires that connect between the gateway 100 and the adaptor 20 and between the gateway 100 and an ADSL modem 80.

A CPU 101 performs terminal management and communication frame generation and reception. A first MAC/PHY 102 controls the MAC layer and the physical layer. The first MAC/PHY 102 has a function of generating a frame from a signal supplied from the adaptor 20 and outputting the frame to the CPU 101, and a function of converting the frame supplied from the CPU 101 into the signal to be supplied to the adaptor 20.

A first pulse transformer (“PT1”) 103 has a function of relaying to a connector 104 the communication signal supplied from the adaptor 20, and a function of relaying to the connector 104 the output communication signal supplied from the first MAC/PHY 102.

A first DC/DC converter (“DC/DC1”) 105 has a function of converting the DC voltage, which has been supplied from the adaptor 20 through the twisted pair cable 71 and the connector 104, to an input voltage that is input to a second DC/DC converter (“DC/DC2”) 106. A voltage output from the first DC/DC converter 105 is supplied to the second DC/DC converter 106 through a first diode 107.

The second DC/DC converter 106 has a function of converting to an internal-use voltage value any one of the voltage supplied from the first DC/DC converter 105 and a voltage supplied from a connector (“CN2”) 108.

The connector 108 is a connector allowing an external AC adaptor to be connected. The connector 108 has a function of drawing the power supply voltage in the event that the power supply voltage is not supplied from the adaptor 20 through the twisted pair cable 71. A power source voltage supplied from the connector 108 is supplied to the second DC/DC converter 106 through a second diode 109.

A second pulse transformer (“PT2”) 110 has a function of supplying to a MAC/PHY 112 the communication signal that has been output from the ADSL modem 80 and that has been input through a connector 111, and a function of supplying the communication signal supplied from the MAC/PHY 112.

The MAC/PHY 112 is a portion that controls the MAC layer and the physical layer, and has a function of generating a frame from the communication signal supplied from the ADSL modem 80 and outputting the frame to the CPU 101, and a function of converting the frame supplied from the CPU 101 to a communication signal to be supplied to the ADSL modem 80.

The adaptor shown in FIGS. 1 and 2 is connected between the gateway 100 and the power line 40.

The adaptor 20 is connected to the power line 40 by being connected to one AC outlet 60.

Communication using the power line 40 is carried out in the manner that a communication signal superimposed on the power line 40 is input into the modem 24 or that the communication signal supplied from the modem 24 is output to the AC outlet 60 through the coupler 23/fuse 22.

The modem 24 demodulates the communication signal supplied from the coupler 23 to thereby generate a 100BASE-TX/10BASE-T packet. The packet thus generated is supplied to the gateway 100 through the pulse transformer 27 and the connector 28. The transfer is carried out in accordance with a procedure specified in 100BASE-TX/10BASE-T specifications.

The modem having received the packet from the terminal through the CN10/pulse transformer performs demodulation in accordance with the procedure for power line communication and superimposes a signal to be supplied onto the power line 40 through the coupler 23/fuse 22.

The AC/DC converter 25 to be supplied with an AC voltage received from the coupler 23 is a circuit that converts the AC voltage to the DC voltage necessary for the terminal. The AC/DC converter 25 is configured with, but not limited to, a rectifier including, for example, a transformer and a diode bridge; a regulator for generating desired voltage and electric current; and a filter circuit for eliminating high frequency components.

The DC voltage generated by the AC/DC converter 25 is supplied to the PE controller 26. The PE controller 26 detects whether the DC voltage signal can be supplied to the gateway 100 through the pulse transformer 27/connector 28 and the twisted pair cable 71.

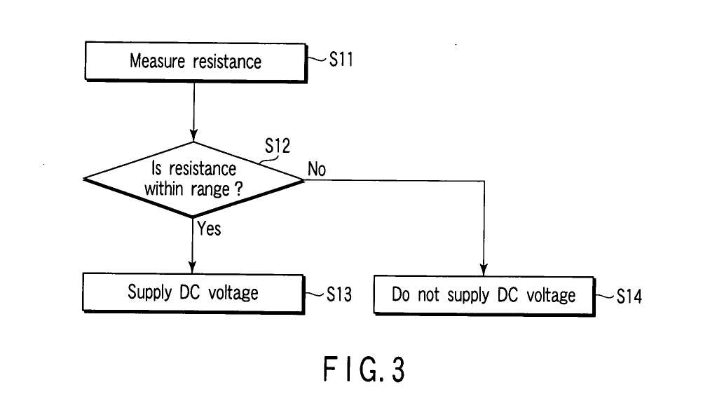

As a method of the detection, a method specified in, for example, IEEE802.3af (Data Terminal Equipment (DTE) power via Media Dependent Interface (MDI)) is utilized. More specifically, the method will be described with reference to a flow diagram shown in FIG. 3. First, the PE controller 26 measures a resistance between two signal lines provided to transmit DC voltage in the twisted pair cable 71 (block S11). The resistance is obtained from either a voltage drop at a constant voltage or a current value at a constant voltage. Then, the PE controller 26 determines whether or not the measured resistance is within a predetermined range (block S12). If the resistance is in the predetermined range (“Yes” at block S12), then the PE controller 26 supplies a DC voltage generated by the AC/DC converter 25 to a midpoint on a primary side (terminal side) of the pulse transformer 27 (block S14). This makes it possible to supply a 100BASE-TX/10BASE-T signal and the power to the terminal through the connector 28 and the twisted pair cable 71. On the other hand, if the measured resistance is out of the predetermined range (“No” at block S12), then the PE controller 26 does not supply the DC voltage to the pulse transformer 27 (block S15).

On the terminal side, since the adaptor is appeared to be connected to a network device (such as a hub or router device) conforming to the IEEE802.3af standards, no special circuit or software other than those conforming to the IEEE802.3af is necessary.

In the event that a terminal requiring power higher than the range specified in the IEEE802.3af standards is necessary to drive the gateway 100, the necessary power can be provided in the manner that the power is supplied from a connector (“CN11”) 29 of the adaptor 20 to the connector 108 of the terminal. In this case, while the gateway 100 and the adaptor 20 are interconnected by two cables, namely, the twisted pair cable 71 and a cable 73 dedicated for DC voltage supply, only one AC outlet 60 is sufficient.

Thus, the power line communication can be implemented with no modifications to terminals or gateway, therefore resolving such an obstacle, against the diffusion, in that the number of devices supporting the power line communication is insufficient. Consequently, the diffusion of the power line communication is enhanced.

The occupation number of the AC plug sockets remains unchanged from the state prior to power line communication. This eliminates the necessities of, for example, rework of wiring, construction associated with, for example, increased plug sockets, and cost increase associated with, for example, increased table taps.

Further, since communication pathways can be secured in any places, limitations in the terminal placement are eliminated, it is possible to easily realize, for example, promotion of the one-device-per-head based usage and new network applications (such as interphones, various networked sensors, and sharing of video contents).

As the communication terminal, a device other than the gateway, such as a router, modem, wireless LAN access point, IP phone, or laptop personal computer, may be used.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A power line communication adaptor comprising:
a power converter section which coverts an alternating current (AC) voltage to a direct current (DC) voltage, the AC voltage is supplied from a plug section which is coupled to a power line plug socket connected to a power line, and the DC voltage drives a communication terminal;
a signal converter section which demodulates a communication signal superimposed on the AC voltage, which converts the demodulated communication signal to a signal defined between the signal converter section and the communication terminal, and which converts the communication signal that is supplied from the communication terminal to a signal compliant with a standard for supply to the power line;
a first connector being to be connected to a first cable configured to transmit a DC voltage supplied from the power converter section and a signal for communication between the signal converter section and the communication terminal; and
a control section which determines whether or not the DC voltage is supplied to the communication terminal and which controls supply of the DC voltage to the connector in response to the determination result.

2. A power line communication adaptor according to claim 1, further comprising separating section which separates the AC signal(voltage) into a high frequency component and a low frequency component, wherein
the high frequency component separated by the separating section is supplied to the signal converter section, and
the low frequency component(commercial power frequency) is supplied to the signal transmission section.

3. A power line communication adaptor according to claim 1, further comprising a second connector being to be connected to a second cable which supplies a DC voltage converted by the power converter section to the communication terminal when a DC power higher than a DC power suppliable to the first cable for driving the communication terminal is necessary.

4. A power line communication adaptor according to claim 1, wherein
the first cable comprises two signal lines which transmit the DC voltage, and
the control section measures a resistance between the two signal lines and determines whether or not the DC voltage is supplied in accordance with the measured resistance.

5. A power line communication adaptor according to claim 4, wherein the control section determines that the DC voltage is supplied, when the resistance is within a predetermined range.

6. A power line communication system, comprising:
a communication terminal including a first connector to which a first cable is connected;
a power line communication adaptor which comprises
a power converter section which coverts an alternating current (“AC”, hereafter) voltage to a direct current (“DC”, hereafter) voltage, wherein the AC voltage is supplied from a plug section which is coupled to a power line plug socket connected to a power line, and the DC voltage is used to drive a communication terminal,
a signal converter section having a function of demodulating a communication signal superimposed on the AC signal and converting the demodulated communication signal to a signal defined between the signal converter section and the communication terminal; and a function of converting the communication signal, that is supplied from the communication terminal, to a signal compliant with a specification for supply to the power line,
a first connector connectable to a first cable capable of transmitting a DC voltage supplied from the power converter section and a signal for communication between the signal converter section and the communication terminal, and
a control section which determines whether or not the DC voltage is supplied to the communication terminal and which controls supply of the DC voltage to the connector in accordance with the determination result.

7. A power line communication system according to claim 6, wherein the power line communication adaptor further comprising; separating section which the AC signal into a high frequency component and a low frequency component, wherein
the high frequency component separated by the separating section is supplied to the signal converter section, and
the low frequency component is supplied to the signal transmission section.

8. A power line communication system according to claim 6, wherein the power line communication adaptor further has a second connector connectable to a second cable which supplies a DC voltage converted by the power converter section to the communication terminal when a power higher than a power suppliable to the first cable for driving the communication terminal is necessary.

9. A power line communication system according to claim 6, wherein
the first cable comprises two signal lines which transmit the DC voltage, and
the control section measures a resistance between the two signal lines and determines whether or not the DC voltage is supplied in accordance with the measured resistance.

10. A power line communication system according to claim 9, wherein, when the resistance is within a predetermined range, the control section determines that the DC voltage is supplied.

11. A power line communication system according to claim 6, wherein the communication terminal is a gateway.
